(19) United States
(12) Patent Application Publication
(10) Pub. No.: US 2002/0070903 A1
(43) Pub. Date: Jun. 13, 2002

(54) Mobile communication terminal and its antenna-mounting structure

(76) Inventors: Yutaka Nakamura, Tokyo (JP); Noboru Koike, Tama-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/941,767

(22) Filed: Aug. 30, 2001

(30) Foreign Application Priority Data
Dec. 11, 2000 (JP) 2000-376399

(51) Int. Cl. H01Q 1/24; H01Q 1/36

(52) U.S. Cl. 343/702; 343/895

(57) ABSTRACT

In the mobile communication terminal of the present invention, a free end portion of a rod type antenna is mounted to one of the longitudinal sides of the housing surface against which the ear is placed during communication such that the antenna can rotate freely between the position along said longitudinal side and the specific position at which the antenna reaches after rotating in a direction distant from the said housing surface against which the ear is placed. By this arrangement, in the non-communication state, the antenna can be held in a position along said longitudinal side of the housing, and in the state of communication, the antenna can be held in a position distant from the housing. By enabling the antenna to rotate in the above-mentioned manner, the antenna can be held away from the housing at the time of communication.

### CROSS-REFERENCE TO RELATED APPLICATIONS

This application is based upon and claims the benefit of priority from the prior Japanese Patent Application No. 2000-376399, filed Dec. 11, 2000, the entire contents of which are incorporated herein by reference.

### BACKGROUND OF THE INVENTION

1. Field of the Invention

The present invention relates to a mobile communication terminal such as cellular telephones, and in particular, its antenna-mounting structure.

2. Description of the Related Art

In general, a conventional mobile communication terminal such as a cellular telephone is equipped with a rod type antenna that can be pulled out of the housing. This antenna is mounted with an angle so that it becomes more distant from one of the surfaces of the housing that is placed against the ear (hereinafter referred to as the housing surface). This is done in order to reduce the lowering of antenna gain caused by the head of the user when the cellular telephone is placed against the ear at the time of communication. In the case of such a mounting method, normally, the rod type antenna will be accommodated in the housing, but because of the inclination, the antenna will protrude from the back surface of the housing. This protrusion will result in increased housing thickness, and hinder good accommodation of the cellular telephone when it is put in brief cases or pockets.

### BRIEF SUMMARY OF THE INVENTION

The object of the present invention is to solve the above-mentioned problem by providing a mobile communication terminal and its antenna-mounting structure that will maintain the performance of the antenna at the time of communication, as well as eliminate the protrusion of the antenna from the housing, thereby decreasing housing thickness and convenient put away in a bag or pocket.

According to the present invention, there is provided a mobile communication terminal and its antenna-mounting structure, characterized by comprising, at least one housing having a longitudinal side, a rod type antenna having a free end, and an antenna holding and rotating mechanism, equipped with the housing, for holding the antenna at a rest position where the antenna is placed along the longitudinal side and rotating the antenna toward an elected position where the free end of the antenna is away from the longitudinal sides.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view that shows the external structure of an antenna-mounting structure according to the present invention when it is applied to an integrated type cellular telephone as the first embodiment.

FIG. 2A and FIG. 2B are a disassembled, perspective view and a cross-sectional view each show the concrete structure of the antenna shaft-supporting portion of the antenna-mounting structure in the first embodiment.

FIG. 3 is a conceptual view that shows how the cellular telephone is used for communication in the first embodiment.

FIG. 4A and FIG. 4B are a perspective view and a side view each show the external structure of an antenna-mounting structure according to the present invention when it is applied to an folding type cellular telephone as the second embodiment.

FIG. 5A and FIG. 5B are a disassembled perspective view and a cross-sectional view each show the concrete structure of the antenna shaft- supporting portion in the second embodiment.

FIG. 6A and FIG. 6B are views that explain the movement of the hinge of the antenna shaft-supporting portion of the antenna-mounting structure in the second embodiment.

FIG. 7 is an enlarged side view explaining the relationship between the opening degree of the lower housing and the upper housing and the rotational movement of the antenna in the second embodiment.

FIG. 8 is a conceptual view that shows how the cellular telephone is used for communication in the second embodiment.

FIG. 9A and FIG. 9B are conceptual views that show the comparison between the antenna feeder system construction in the second embodiment of the present invention and that of the conventional one.

FIG. 10 is a perspective view that shows the external structure of the antenna-mounting structure according to the present invention when it is applied to an integrated type cellular telephone as the third embodiment.

FIG. 11 is a conceptual view that shows how the cellular telephone is used for communication in the third embodiment.

FIG. 12A and FIG. 12B are a perspective view and a side view that show the external structure of the antenna-mounting structure according to the present invention when it is applied to a folding type cellular telephone as the fourth embodiment.

FIG. 13 is a conceptual view that shows how the cellular telephone is used for communication in the fourth embodiment.

### DETAILED DESCRIPTION OF THE INVENTION

Detailed explanation of the embodiments of the present invention is given below by referring to the accompanying drawings.

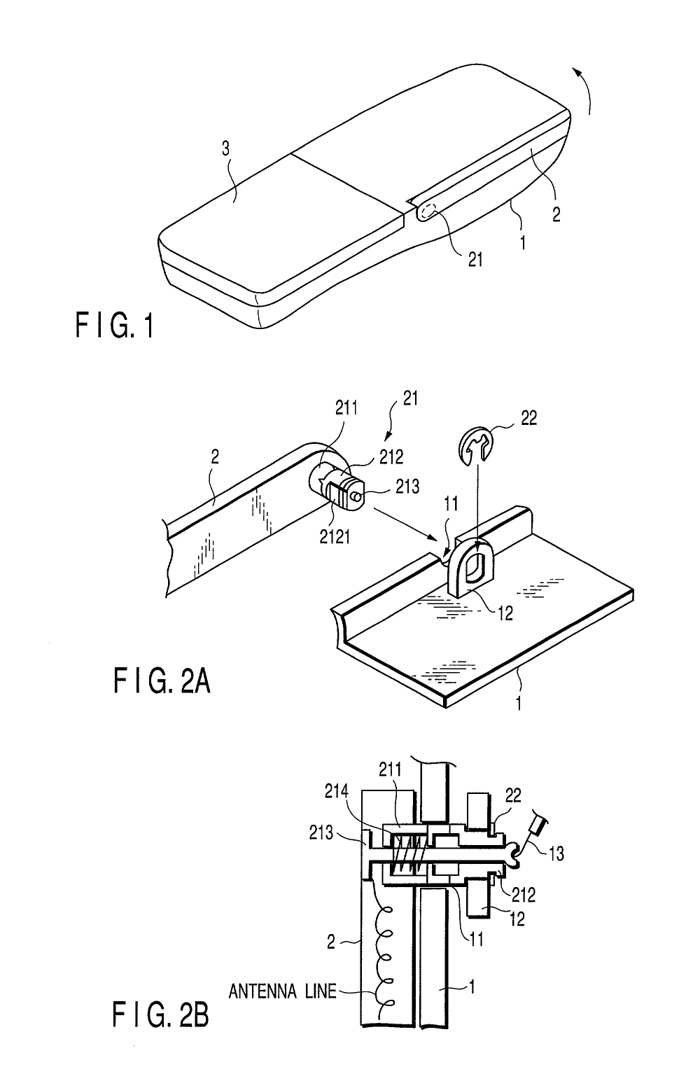

FIG. 1 is a perspective view that shows the external structure of the antenna-mounting structure according to the present invention when it is applied to an integrated type cellular telephone as the first embodiment. In FIG. 1, 1 stands for an housing, 2 stands for an antenna, and 3 stands for a battery pack. The antenna 2 has a length corresponding to the wavelength used. In the housing 1, in one of the longitudinal sides of the back surface (the surface opposite to the surface against which the ear is placed), from the middle to the top, a notched portion to accommodate said antenna 2 is formed. The antenna 2 is formed by suitably molding a resin so that its shape will match the shape of the entire housing 1.

The antenna 2 is mounted to the housing 1 and supported at its end near the middle of the housing 1 such that it can revolve freely in the direction distant from the housing surface against which the ear is placed.

FIG. 2A and FIG. 2B indicate the concrete structures of the shaft-supporting portion of said antenna 2. FIG. 2A is a perspective view, and FIG. 2B is a cross-sectional view. The shaft-supporting mechanism of the antenna 2 uses a built-in spring hinge 21.

This hinge 21 is equipped with a cylindrical base portion 211 of hollow structure and a rotating portion 212 which is arranged to face said base portion 211. These portions are supported by a shaft 13 such that they can rotate freely, and can move slightly in the shaft direction. To the base portion 211 a spring 214 is built-in, and by this spring 214 the base portion 211 and the rotating portion 212 are connected, thereby adding force to both in a pulling direction at all times. The rotating portion 212 is formed so that the side corresponding to the base portion 211 is a cylindrical shape, and the opposite side is roughly an elliptical shape, and at the same time a groove 2121 for fitting an E ring 22 is formed.

In addition, at the side facing the base portion 211 and the rotating portion 212, a plurality of convex portions and concave portions are formed so that the rotating portion 212 will stop at the standard position and at the position at which the rotating portion 212 reaches after it has turned for a specific angle. By this structure, a notch mechanism is realized.

The hinge 21 with the above-mentioned structure, has the base portion 211 and one end of the shaft 213 fixed to the end of the antenna 2 in a direction perpendicular to the longitudinal direction of said antenna.

The housing 1 has a hole (In FIG. 2A, this is shown as a semicircle because it is a disassembled view) 11 formed in the antenna shaft-supporting portion. Inside of it, there is provided a shaft-bearing portion 12 having a hole of which the shape is the same as the cross section of the end of the rotating portion 212 of the hinge 21. The hinge 21 that has its base portion 211 fixed to the antenna 2 is inserted from the hole 11 provided in the notched portion of the housing 1. After inserting the rotating portion 212 to the hole of the shaft-bearing portion 12 inside the housing 1, fit the E ring 22 into the groove 2121 of the rotating portion 212. By doing so, the rotating portion 212 will be fixed by the shaft-bearing portion 12 of the housing 1.

In the above-mentioned structure, between the base portion 211 and the rotating portion 212, a pulling force is working at all times by the internal spring 214. By a plurality of convex portions and concave portions formed between said two portions, there is a notched mechanism which enables stopping at a specific angle. Owing to the above, if the antenna 2 is turned in a direction distant from the back surface of the housing 1, it will stop at a specific position due to said notched mechanism. When returning the antenna 2 to its original accommodating position of the housing, push the antenna toward the housing and the antenna will stop at a predetermined accommodating position of the housing by said notched mechanism. In the above-mentioned way, the antenna 2 can be maintained at two positions, namely, the accommodating position of the housing 1, and a specific position distant from the housing 1.

If a conductive metal is used for said shaft 213, a feeder line 13 inside the housing 1 and the antenna 2 are electrically connected through the shaft 213. Thus, the electrical feeding can be performed well, even if the antenna is rotated.

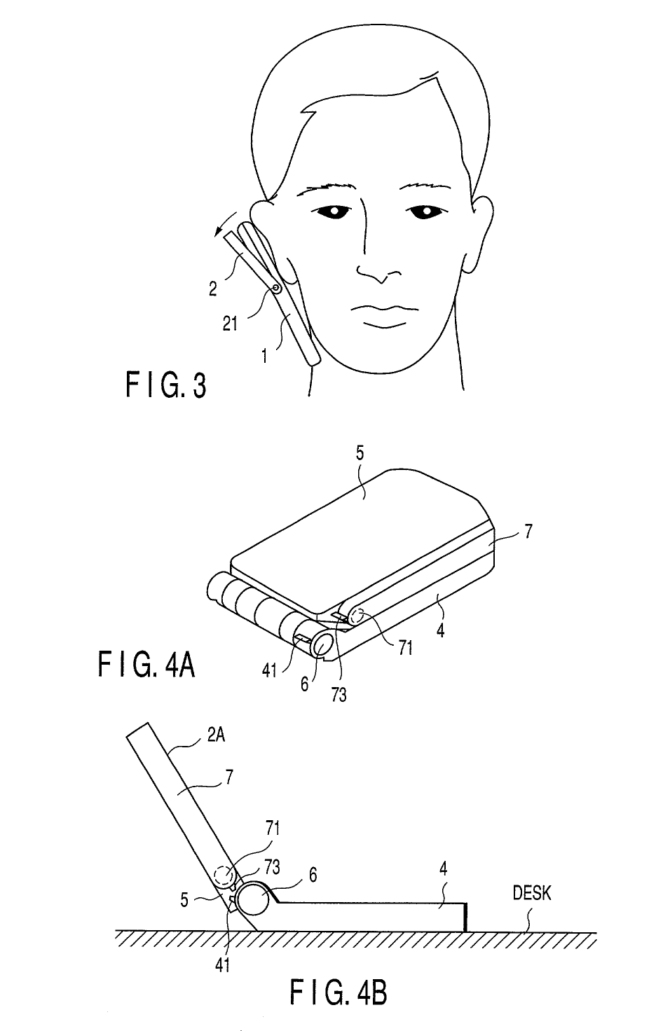

In this case, according to the antenna-mounting structure of the present embodiment, as shown in FIG. 3, at the time of communication, the antenna 2 is held at a position distant from the housing 1. When the cellular telephone is put in brief cases or the pockets, the antenna can be held at a position along one of the longitudinal sides of the housing 1. Therefore, while maintaining the performance of antenna 2, the protrusion of the antenna can be eliminated from the housing, and the housing 1 can have a decreased thickness, and convenient put away in bag or packet.

FIG. 4A and FIG. 4B each show the external structure of the antenna-mounting structure of the present invention when it is applied to a folding type cellular telephone as the second embodiment. FIG. 4A is a perspective view showing the telephone in the folded state, and FIG. 4B is a side view showing the telephone placed on a desk, etc., in the open state.

In FIG. 4A and FIG. 4B, 4 stands for a lower housing which is placed near the user's mouth when the user is communicating, and 5 stands for an upper housing which is placed against the ear during communication. Both are connected with a hinge mechanism 6 so that they can turn freely.

In this embodiment, an antenna 7 is mounted to the upper housing 5. This is because, in case the cellular telephone is placed on a desk, etc., in the folded state, it will be easier to move the antenna away from the shielding objects.

In order to mount the antenna 7 to the upper housing 5, the width of the upper housing 5 is made narrower than the width of the lower housing 4, and a space to accommodate the antenna 7 is formed along one of the longitudinal sides of the upper housing 5. The antenna 7 is formed by suitably molding a resin so that its shape will match the entire shape of the upper housing 5. Its end portion is supported such that, in the upper housing 5, it can rotate freely in a direction distant from the housing surface against which the ear is placed.

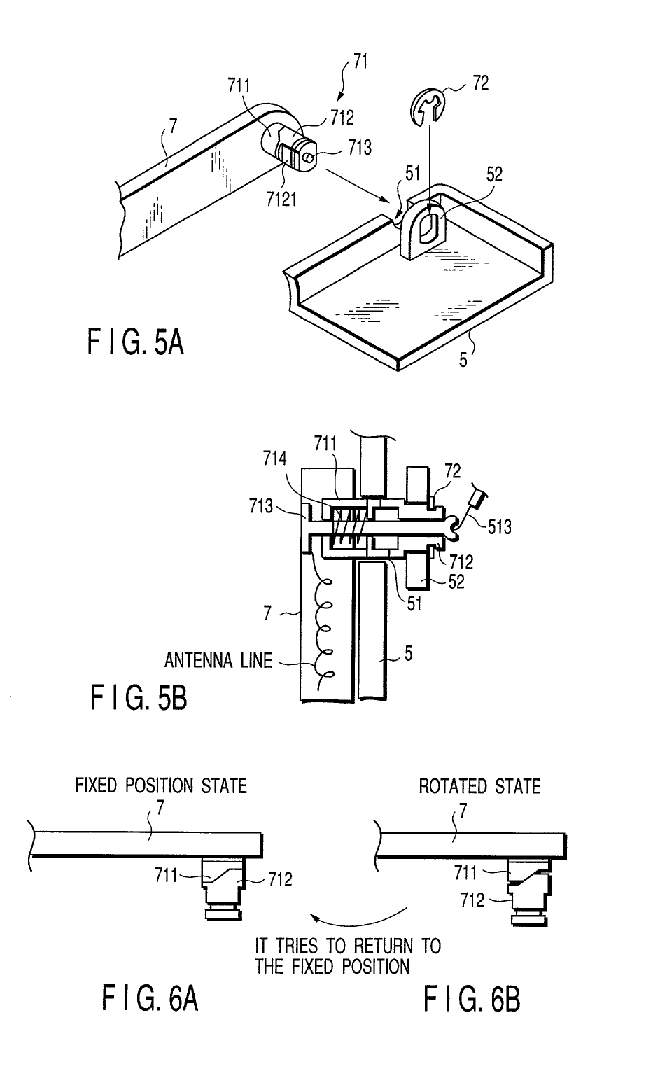

FIG. 5A and FIG. 5B each show the concrete structure of the shaft- supporting portion of the antenna 7. FIG. 5A is a disassembled perspective view and FIG. 5B is a cross-sectional view. As for the shaft-supporting mechanism of the antenna 7, a hinge 71 possessing a built-in spring having a structure similar to the hinge 21 shown in FIG. 2 is used.

The aforementioned hinge 71 consists of a base portion 711, a rotating portion 712, a shaft 713, and a built-in spring 214. The base portion 711 and the rotating portion 712 are supported by the shaft 713 such that the hinge can rotate freely and also can move slightly in the shaft direction. By the built-in spring 214, force will be added in the mutually pulling direction. As for the rotating portion 712, the side corresponding to the base portion 711 is formed into a cylindrical shape and the opposite side is formed into a roughly elliptical shape, and also a groove 7121 for fitting an E ring 72 is formed.

In this case, to the side facing the base portion 711 and the rotating portion 712 are cut slantwise against the rotating shaft, unlike the hinge 21 shown in FIG. 2A and FIG. 2B.

The hinge 71 with the above-mentioned structure has the base portion 711 and one end of the shaft 713 fixed to the end portion of the antenna 7 so that they would be perpendicular to the longitudinal direction of the antenna 7.

In the upper housing 5, a hole (In FIG. 5A it is shown as a semicircle since it is a disassembled view) 51 is formed in the antenna-supporting portion. Inside of it, there is provided a shaft-bearing portion 52 possessing a hole of which the shape is the same as the cross section of the end of the rotational portion 712 of the hinge 71. The hinge 71 of which the base portion 711 is fixed to the antenna 7 is inserted from the hole provided in the notched portion of the upper housing 5. After inserting the rotational portion 712 into the hole of the shaft-bearing portion 52, fit the E ring 72 into the groove 7121 of the rotational portion 712. By doing so, the rotational portion 712 will be fixed by the shaft-bearing portion 52 of the upper housing 5.

Furthermore, if a conductive metal is used for the above-mentioned shaft 713, a feeder line 53 inside of the housing 5 and the antenna 7 can be electrically connected through the shaft 713. Thus, electrical feeding can be performed well, even if the antenna 7 is rotated, as in the first embodiment.

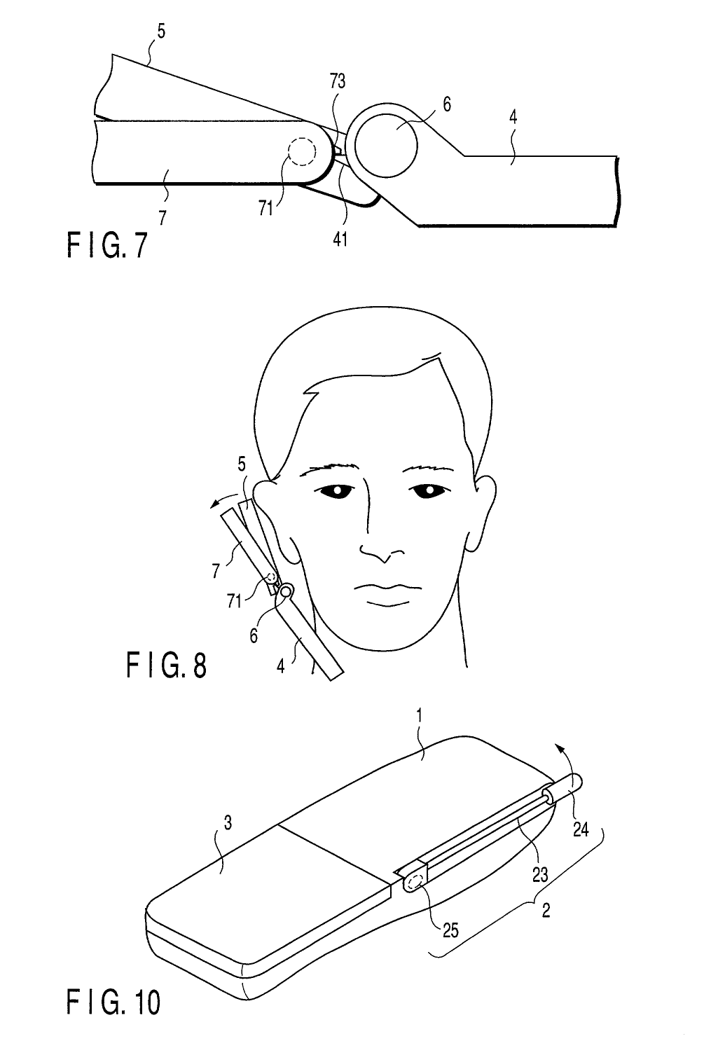

As shown in FIG. 6A, at a specific point on the longitudinal side of the upper housing 5, the connecting surfaces of the base portion 711 and the rotational portion 712 are made to match. Between the base portion 711 and the rotational portion 712 a force to mutually pull towards each other is working at all times by the spring 714 inside, the two are cut slantwise in relation to the rotational shaft. By doing so, if the antenna 7 is rotated from the specific position towards a direction distant from the back surface of the upper housing 5. As shown in FIG. 6B, against the force added by the built-in spring 714, the base portion 711 and the rotating portion 712 will expand in the shaft direction. Therefore, if the force to turn the antenna 7 in a direction distant from the back surface does not act, the antenna 7 will resume its original position naturally.

As shown in FIG. 4A and FIG. 4B, at the end of the rotating portion side of the antenna 7, a protrusion portion 73 is formed. At the hinge-bearing portion of the lower housing 4, at the time the antenna 7 rotates, at a position where the above-mentioned protrusion 73 comes into contact, a protrusion 41 is formed.

The protrusion portion 73 of the antenna 7 and the protrusion portion 41 of the lower housing 4 are not engaged in the folded state. But when the opening angle of the lower housing 4 and the upper housing 5 reaches a specific value, the two will become engaged. If the angle exceeds the specific angle, as shown in FIG. 7, the protrusion 41 of the lower housing 4 pushes up the protrusion portion 73 of the antenna 7. By doing this, the antenna 7 will act against the force of the built-in spring of the hinge 71, and from the specific position of the upper housing 5, it will open towards the outside. At the state in which the lower housing 4 and the upper housing 5 are opened to the maximum, the antenna 7 will stop at a position where it is located away from the back surface of the upper housing 5. If the lower housing 4 and the upper housing 5 are folded, by the action of the hinge 71, the antenna 7 will return to the specific position of the longitudinal side of the upper housing 5.

Therefore, according to the antenna-mounting structure of the present embodiment, at the time of making communication, the antenna 7 is maintained at a position distant from the upper housing 5 as shown in FIG. 8. When it is put in brief cases or pockets, the antenna can be accommodated in a position along the longitudinal side of the upper housing 5. Thus, the protrusion of the antenna can be eliminated from the upper housing 5 while maintaining the performance of the antenna 7 at the time of communication, and the whole housing can have a decreased thickness and improved accommodation can be realized.

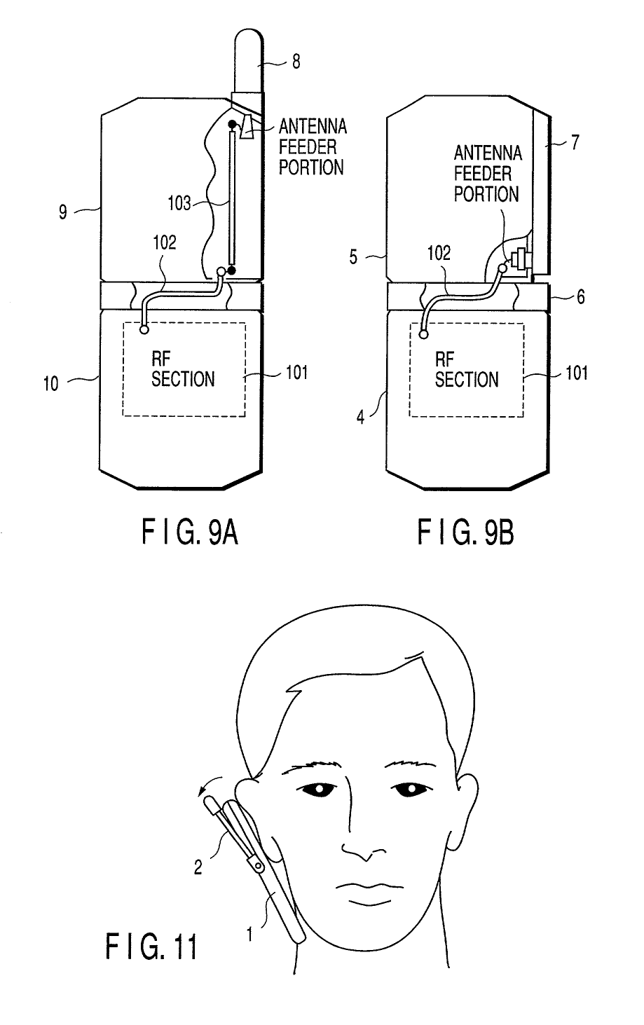

Furthermore, in the case of conventional folding type cellular telephones, as shown in FIG. 9A, at the time of pulling out an antenna 8, in order to feed the antenna 8, it was necessary to make a feeding point at the top of the upper housing. As a result, when a RF (radio frequency) section 101 was arranged on the lower housing 10, not only it was necessary to provide a coaxial cable 102 from the lower housing 10 to the upper housing 9 as a feeder line, but also to provide a coaxial semi-rigid cable 103 in the upper housing.

Contrary to this, according to the structure of the present embodiment, as shown in FIG. 9B, the shaft 713 of the hinge 71 that supports the antenna 7 so that it can rotate, functions as a feeder line, and its position is close to the hinge mechanism 6. Therefore, even in the case where the RF section 101 is arranged on the lower housing 4, all that is required is a coaxial cable 102 as a feeder line from the lower housing 4 to the upper housing 5. In addition, since the distance of stretching the coaxial cable will become shorter in comparison with the conventional ones, there is the advantage of decreasing loss.

FIG. 10 is a perspective view that shows the external structure if the antenna-mounting structure according to the present invention is applied to an integrated type cellular telephone as the third embodiment. FIG. 11 is a view that shows the state of communication. Furthermore, in FIG. 10 and FIG. 11, for the same parts as FIG. 1 and FIG. 3, the same reference symbols are used, and duplicated explanation is omitted here.

In the present embodiment, the point that differs from the first embodiment is that a rod antenna portion 23 and a helical antenna portion 24 were integrated to form the antenna 2. In this case, the structure of a shaft-supporting portion 25 for mounting the antenna 2 to the housing 1 such that it can rotate freely, may be completely the same structure as that shown in FIG. 2A and FIG. 2B.

Therefore, even by the antenna-mounting structure of the present embodiment, at the time of communication, the antenna 2 can be held in a position distant from the housing 1. As a result, at the time of communication, while maintaining the performance of the antenna 2, the protrusion of the antenna can be eliminated from the housing 1, whereby the housing 1 can have a decreased thickness, and improved accommodation can be realized.

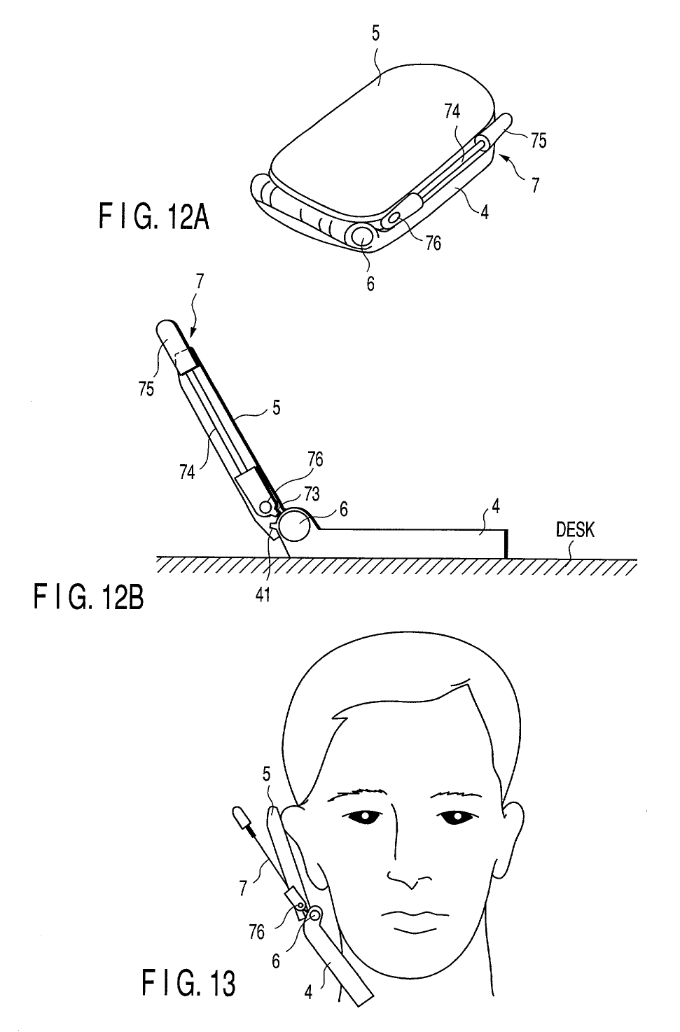

FIG. 12A and FIG. 12B each show the external structure of the antenna-mounting structure according to the present invention when it is applied to a folding type cellular telephone as the fourth embodiment. FIG. 12A is a perspective view showing the telephone in the folded state, and FIG. 12B is a side view showing the telephone placed on a desk, etc., in the open state.

In addition, FIG. 13 is a view that shows the state of communication. Furthermore, in FIG. 12A, FIG. 12B, and FIG. 13, the same reference symbols as those shown in FIG. 4A, FIG. 4B, and FIG. 8 are used for identical parts. Thus, duplicated explanation is omitted here.

In the present embodiment, the point that is different from the second embodiment is that a rod antenna portion 74 and a helical antenna portion 75 are integrated to form the antenna 7. In this case, the structure of a shaft-supporting portion 76 for mounting the antenna 7 to the upper housing 5 such that it can rotate freely, may be exactly the same structure as that shown in FIG. 5A and FIG. 5B.

Therefore, in the case of the antenna-mounting structure of this embodiment, as shown in FIG. 13, the antenna 7 is held in a position distant from the upper housing 5 at the time of communication. When put away in brief cases or pockets, the antenna 7 can be held along the longitudinal side of the upper housing 5. Therefore, the protrusion of the antenna 7 can be eliminated while maintaining the performance of the antenna 7 at the time of communication, and the entire housing can have a decreased thickness and improved antenna accommodation can be realized.

As mentioned above, according to the present invention, it is possible to provide a mobile communication terminal and its antenna-mounting structure that realize the elimination of the antenna protrusion while maintaining the antenna performance at the time of communication, and also decrease housing thickness and convenient put away in a bag or pocket.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An antenna-mounting structure of a mobile communication terminal comprising:
at least one housing having a longitudinal side;
a rod type antenna having a free end; and
an antenna holding and rotating mechanism, equipped with the housing, for holding the antenna at a rest position where the antenna is placed along the longitudinal side and rotating the antenna toward an elected position where the free end of the antenna is away from the longitudinal side.

2. The antenna-mounting structure according to claim 1, wherein said mobile communication terminal is folding type having a pair of housings that are connected with hinges.

3. The antenna-mounting structure according to claim 1, wherein the antenna holding and rotating mechanism being interlocked with an opening motion of the pair of housings, rotating the antenna toward the elected position where the free end of the antenna is away from the longitudinal side in response to the opening motion of the folded pair of housings.

4. The antenna-mounting structure according to claim 1, wherein at the free end of the rod type antenna, a helical type antenna is formed.

5. A mobile communication terminal used in a cellular telephone network comprising:
at least one housing having a longitudinal side;
a rod type antenna having a free end; and
an antenna holding and rotating mechanism, equipped with the housing, for holding the antenna at a rest position where the antenna is placed along the longitudinal side and rotating the antenna toward an elected position where the free end of the antenna being away from the longitudinal side.

6. The mobile communication terminal according to claim 5, wherein said terminal is folding type having a pair of housings that are connected with hinges.

7. The mobile communication terminal according to claim 6, wherein the antenna holding and rotating mechanism being interlocked with an opening motion of the pair of housings, rotating the antenna toward the elected position where the free end of the antenna is away from the longitudinal side in response to the opening motion of the folded pair of housings.

8. The mobile communication terminal according to claim 6, wherein at the free end of the rod type antenna, a helical type antenna is formed.
